(19) United States
(12) Patent Application Publication
(10) Pub. No.: US 2026/0268596 A1
(43) Pub. Date: Sep. 10, 2026

(54) REAL TIME DIGITAL TWIN SYSTEM AND METHOD

(71) Applicant: INTERAPTIX INC., Toronto (CA)

(72) Inventors: Dae Hyun LEE, Etobicoke (CA); Bardia BINA, Toronto (CA); Luke Andrew ELLIOTT, Oakville (CA)

(21) Appl. No.: 19/165,566

(22) PCT Filed: Jun. 27, 2024
(86) PCT No.: PCT/IB2024/056274

§ 371 Date: Sep. 15, 2025

Related U.S. Application Data
(60) Provisional application No. 63/523,408, filed on Jun. 27, 2023.
(60) Provisional application No. 63/533,111, filed on Aug. 16, 2023.

(51) Int. Cl. G06T 17/00; G06T 7/12; G06T 7/246; G06T 7/33; G06T 7/73

(52) U.S. Cl. CPC G06T 17/00; G06T 7/12; G06T 7/248; G06T 7/337; G06T 7/74; G06T 2207/10016; G06T 2207/20021

(57) ABSTRACT

The present specification provides a method and system for computing a digital twin of a subject, which can enhance remote inspection and information retrieval. This system uses multiple fixed and movable capture devices, such as headsets and drones, to continuously collect image frames and telemetry data. The collected data is processed by a digital twin engine to create and update a comprehensive, real-time, or periodically updated three-dimensional digital twin. This method improves over traditional video feeds by enabling full 3D navigation and inspection of spaces like rooms, buildings, and vehicles.

### CROSS-REFERENCE TO RELATED APPLICATIONS

This application claims the benefit of U.S. Provisional Patent Application No. 63/523408 entitled “CONTINUOUS SCANNING”, filed Jun. 27, 2023, and U.S. Provisional Patent Application No. 63/533111 entitled “REAL TIME DIGITAL TWIN SYSTEM AND METHOD”, filed Aug. 16, 2023, the entire contents of which are incorporated herein by reference.

### FIELD

The present specification is directed to the field of digital imaging and modeling. More specifically, it pertains to methods and systems for capturing images of an environment and generating a digital representation of that environment.

### BACKGROUND

Advancements in computing, imaging, networking, and cloud technologies are driving significant progress in virtual and augmented reality experiences through enhanced data transmission, high-resolution digital capture, and rapid image processing. Despite these advancements, significant hardware limitations persist. These limitations include battery life constraints, processing speed, memory, and input/output (IO) speed. These constraints collectively pose challenges to the creation of digital twins: digital models of real-world objects and environments.

### SUMMARY

An aspect of the present specification provides a system and method for computing a digital twin.

In a first aspect, a method of computing a digital twin is provided. The method includes capturing, at a plurality of capture devices, image frames representing the subject at respective scanning times. The method further includes establishing a root in at least one of the image frames and estimating pose information for each image frame relative to the root. The method also involves transmitting the image frames from the plurality of capture devices to a digital twin engine. The method includes aligning the image frames with existing frames in the digital twin based on feature matching and pose estimation. An intermediate digital twin is then built at the digital twin engine based on the alignment of the image frames. Finally, the image frames are aligned at the digital twin engine according to the respective scanning times to build the final digital twin.

In another aspect, the method is performed continuously or periodically to update the digital twin.

In a further aspect, building the intermediate digital twin includes accumulating image frames from the plurality of capture devices. It also includes defining a boundary for the subject, dividing the subject into segments, and building the intermediate digital twin by assembling the segments.

In yet another aspect, the plurality of capture devices includes both fixed capture devices and movable capture devices. The method further includes monitoring the subject by capturing image frames at one of the fixed capture devices and comparing the image frames to the existing frames. If no non-transient changes have occurred, the subject is further monitored. If a non-transient change is detected, a segment of the digital twin associated with the image frame is identified as invalid. The method then controls one of the movable capture devices to capture replacement image frames of the invalid segment and updates digital twin by replacing the invalid image frames with the replacement image frames.

In another aspect, the method includes estimating pose information for the image frames. It also includes selecting reference images from the existing images, estimating pose information for the reference images, comparing the pose information of the image frames with the pose information of the reference images, and correcting the pose information for the image frames based on the comparison.

In a further aspect, the plurality of capture devices includes a first capture device and a second capture device, and the image frames captured by the first and second capture devices are processed according to the processing capacity of the respective capture device.

In yet another aspect, the image frames comprise video frames and the first capture device further collects inertial measurement unit (IMU) data. The method further includes estimating the pose information for each image frame at the first capture device using a simultaneous localization and mapping (SLAM) algorithm. Aligning the image frames with the existing frames is performed by the first capture device.

In another aspect, the image frames comprise video frames. Aligning the image frames with the existing frames includes executing a structure from motion (SfM) algorithm at the digital twin engine.

In a further aspect, the first capture device is movable and includes an IMU sensor to detect when the first capture device is stationary or in motion. Capturing the image frames is performed only when the first capture device is stationary.

In yet another aspect, the image frames include photos. The method further includes estimating the pose information for each image frame at the first capture device using an ARKit™ application programming interface and a simultaneous localization and mapping (SLAM) algorithm.

In another aspect, a system for computing a digital model of a subject is provided. The system includes a plurality of capture devices configured to generate image frames representing a portion of the subject at respective scanning times. The system also includes a digital twin engine configured to receive the image frames from the plurality of capture devices via a network. The digital twin engine establishes a root in at least one of the image frames. It aligns the image frames with existing frames in the digital twin based on the root. The system then builds an intermediate digital twin based on the alignment of the image frames. Finally, the digital twin engine aligns the image frames with the respective scanning times to construct the final digital twin. The system includes a retrieval computing device for outputting the digital twin.

In a further aspect, the plurality of capture devices includes at least a first capture device configured to establish the root and align the image frames with the existing frames.

In yet another aspect, the plurality of capture devices includes one or more of a video camera, a video phone, a digital camera, a headset, a tablet computer, and a drone.

In another aspect, the plurality of capture devices includes both fixed capture devices and movable capture devices.

In a further aspect, the retrieval computing devices is selected from the group consisting of a virtual reality device, a personal computing device, a smartphone, a tablet computer, and an augmented reality device.

In a further aspect, the plurality of capture devices includes at least a first capture device including a sensor for capturing telemetry data.

Methods, systems, devices, apparatuses and computer readable media storing programming instructions, according to any the foregoing, or combinations or variants thereof, are contemplated.

### BRIEF DESCRIPTION OF THE FIGURES

FIG. 1 is a schematic diagram of a system for computing a digital twin.

FIG. 2 is an illustration of an exemplary image frame suitable for processing by the system of FIG. 1.

FIG. 3 is a block diagram of example internal components of the digital twin engine of FIG. 1.

FIG. 4 is a flowchart depicting a method of computing a digital twin.

FIG. 5 is a flowchart depicting exemplary performance of block 420 of FIG. 4.

FIG. 6 is a flowchart depicting an exemplary method of monitoring a subject using the system of FIG. 1.

### DETAILED DESCRIPTION

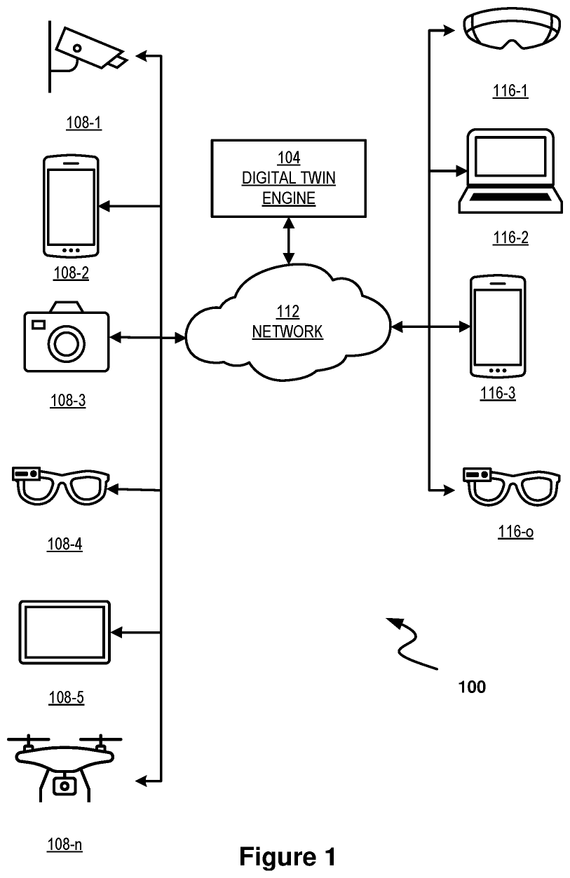

FIG. 1 shows a real time digital twin system indicated generally at 100. System 100 comprises a digital twin engine 104 connected to a plurality of capture devices 108-1, 108-2 . . . 104-n via a network 112. (Collectively, devices 108-1, 104-2 . . . 104-n are referred to as devices 108, and generically, as device 108. This nomenclature is used elsewhere herein.) Engine 104 also connects to at least one retrieval computing device 116. In FIG. 1 and system 100, engine 104 is a virtual or cloud-based engine on a virtual or cloud-based server with many mirrors, however in other embodiments, engine 104 can be located on a physical server or on one of the computing devices 116.

In system 100, network 112 can be any wired and/or wireless network topology is contemplated, such as, by way of non-limiting example, the Internet, one or more intranets, or combinations thereof.

Capture devices 108 can be based on any presently known or future developed computing device that can capture telemetry data of a subject. Telemetry data typically includes images, but can include video, sound, temperature, pressure, orientation, depth, movement, and location. In specific non-limiting examples, the telemetry data includes inertial measurement units (IMU), Light Detection and Ranging (LiDAR) data, Time-of-Flight (ToF) data, ultrasound data, infrared data, sonar scan data, structured light scanning, and combinations thereof. Similarly, “subject” is a non-limiting term. In certain embodiments, a subject typically includes a space within a physical structure such as a room but can also be individual objects. When the subject is a room, then the subject can include all of the fixed structural elements including the floors, ceilings, walls, pillars, doors, and windows. Furthermore, in a room, the subject may also include all the movable objects in the room and their positions. Such telemetry data can be used to build a digital twin of the subject.

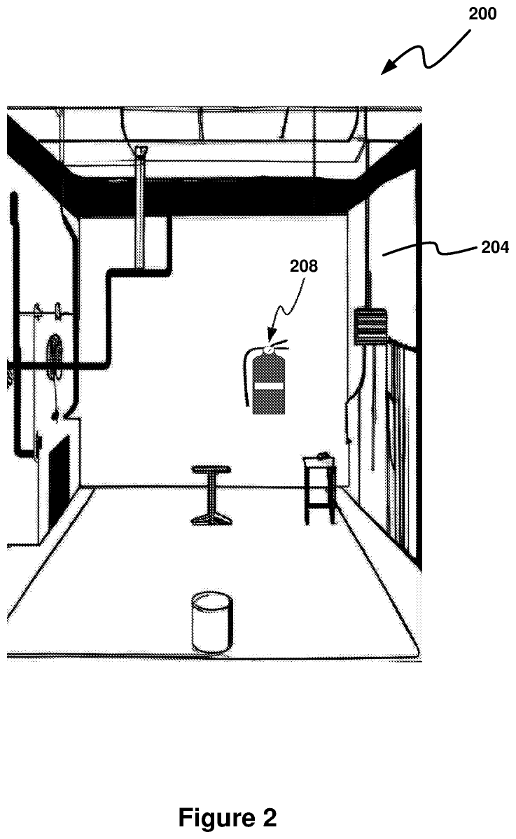

FIG. 2 is an illustration of an exemplary frame 200 captured by capture device 108. In the non-limiting example shown, the frame 200 comprises an image depicting a room 204. Thus, capture devices 108 are all configured to capture images (and/or other telemetry) of room 204, including various objects in room 204. An example object is fire extinguisher 208. Other objects are shown in room 204 but are not labelled for simplicity, but the example discussion around the movement and relocation of fire extinguisher 208 will apply to all objects and other structural elements and objects within room 204. The totality of the elements shown in room 204 may be captured as images by devices 108 to obtain a real time digital twin of room 204. (The teachings herein can be applied to obtaining real time digital twins of other subjects.)

As explicitly shown in FIG. 1, capture devices 108 can thus include a video camera capture device 108-1, a video phone capture device 108-2, a digital camera capture device 108-3, a headset capture device 108-4, a tablet computer capture device 108-5 and a drone 108-n. Capture devices 108 typically at least include a camera, but can also include other sensors or input devices to capture various types of telemetry data Other types of capture devices 108 are contemplated, such as body cameras.

Some capture devices 108 can be permanently fixed, while other capture devices 108 can be movable. For example, video camera capture device 108-1 may be permanently mounted on the wall or ceiling of room 204. Images captured by video camera capture device 108-1 can be constantly or periodically captured and delivered to digital twin engine 104. By the same token, video phone capture device 108-2 may also be permanently mounted on the wall of room 204, with the camera function of the video phone capture device 108-2 being “on” or periodically activated, to capture images of room 204 and delivered to digital twin engine 104. It is to be noted that even with a plurality of permanent capture devices 108 (such as device 108-1 and device 108-2) deployed within room 204, only portions of room 204 will be within the field of view. Accordingly, other capture devices 108 are movable throughout the room 204 to capture images of what the fixed devices 108 cannot. For example, digital camera capture device 108-3, (which could be a bodycam or standalone camera), headset capture device 108-4, tablet computer capture device 108-5 and drone 108-n are all movable throughout room 204. Movable capture devices 108-3, 108-4 . . . 108-n can be intentionally deployed within room 204 to capture images of room 204. Movable capture devices 108-3, 108-4 . . . 108-n may also be incidentally deployed. For example, if device 108-3 is being worn as a bodycam, then as the wearer walks through room 204 for some unrelated purpose to image capture of room 204, then body-cam device 108-3 can be activated to obtain a portion of images that represent room 204.

Note that permanent or fixed capture devices 108 (such as device 108-1) can be configured to continuously scan room 204, whereas movable capture devices 108 (such as devices 108-3, 108-4 . . . 108-n) may only capture a portion of room 204 at a portion of time. Information from movable capture devices 108 may also capture images from different angles than fixed capture devices 108. However, where fixed capture devices 108 have viewing angles that overlap with movable devices 108, then if information or content based on images from fixed capture devices 108 changes, then when movable devices 108 re-enter the room 204, those moveable capture devices 108 can be instructed to focus on capturing such changed information or content. In this way, fixed capture devices 108 can constantly validate or invalidate the real-time or present accuracy of whatever images are being captured.

As explicitly shown in FIG. 1, retrieval computing devices 116 can thus include a virtual reality device 116-1, a personal computing device 116-2, a smartphone 116-3, a tablet computer 116-5, and an augmented reality (AR) device 116-o. Retrieval computing devices 116 typically at least include a display for outputting the digital twin, but can also include a processor, memory, network interface, and one or more input devices.

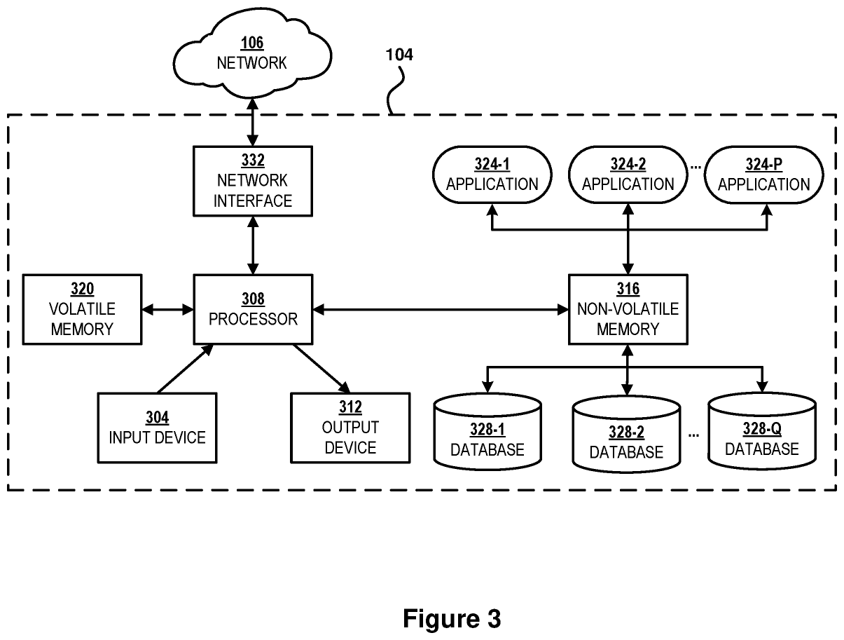

FIG. 3 shows a schematic diagram of a non-limiting example of internal components of digital twin engine 104. In this example, engine 104 is depicted as a physical engine, however in other examples, engine 104 is a virtual engine and one or more components of FIG. 3 are simulated by the virtual server In this example, engine 104 includes at least one input device 304. Input from input device 304 is received at a processor 308 which in turn controls an output device 312. In the context of all the nodes of system 100, input device 304 can be a traditional keyboard and/or mouse may be connected to provide physical input. Likewise output device 312 can be a display or audio speakers. In variants, additional and/or other input devices 304 or output devices 312 are contemplated or may be omitted altogether as the context requires.

Processor 308 may be implemented as a plurality of processors or one or more multi-core processors and may include one or more graphics processing units (GPUs). The processor 308 may be configured to execute different programing instructions responsive to the input received via the one or more input devices 304 and to control one or more output devices 312 to generate output on those devices.

To fulfill its programming functions, the processor 308 is configured to communicate with one or more memory units, including non-volatile memory 316 and volatile memory 320. Non-volatile memory 316 can be based on any persistent memory technology, such as an Erasable Electronic Programmable Read Only Memory (“EEPROM”), flash memory, solid-state hard disk (SSD), other type of hard-disk, or combinations of them. Non-volatile memory 316 may also be described as a non-transitory computer readable media. Also, more than one type of non-volatile memory 316 may be provided.

Volatile memory 320 is based on any random-access memory (RAM) technology. For example, volatile memory 320 can be based on a Double Data Rate (DDR) Synchronous Dynamic Random-Access Memory (SDRAM). Other types of volatile memory 320 are contemplated.

Processor 308 also connects to network 106 via a network interface 332 which includes a buffer, a modulator/demodulator or MODEM, over the various links and/or internet that connects the server equipment to other server equipment. Depending on the node in system 100, network interface 332 can also be used to connect a given node to another computing device that has an input and output device, thereby obviating the need for input device 304 and/or output device 312 altogether.

Programming instructions in the form of applications 324 are typically maintained, persistently, in non-volatile memory 316 and used by the processor 308 which reads from and writes to volatile memory 320 during the execution of applications 324. One or more tables or databases 328 can also be maintained in non-volatile memory 316 for use by applications 324.

A variant of the hardware infrastructure of engine 104 from FIG. 3 can be used to implement capture devices 108 but based on their own unique input and output hardware form factors as human-machine interfaces. In the specific context of devices 108, input devices may include any telemetry sensors including physical or virtual keyboards, accelerometers, input buttons, pointing devices, treadmills, temperature sensors, cameras, microphones, global positioning systems (GPS), gyroscopes, velocity sensors, accelerometers, or any other known or future contemplated input device associated with human-machine interfaces. In the context of capture devices 108, output devices may include traditional displays, head-set stereoscope virtual reality displays, augmented or mixed reality displays, haptic feedback, heating or cooling apparatuses, smell generators, sound devices, surround sound systems, smart light bulbs, smart light strips, or any other known or future contemplated output devices associated with human-machine interfaces.

A variant of the hardware infrastructure of engine 104 from FIG. 3 can also be used to implement computing devices 116 but based on their own unique input and output hardware form factors as human-machine interfaces. As will be discussed in greater detail below, computing devices 116 are configured to retrieve and otherwise interact with digital twins captured by devices 108 and processed by engine 104.

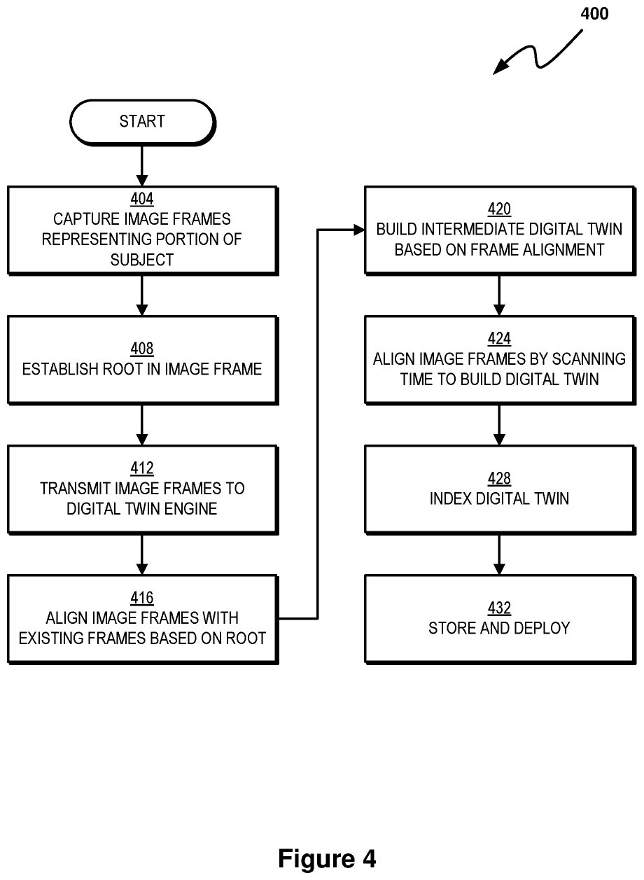

FIG. 4 shows a flowchart depicting a real time digital twin method indicated generally at 400. Method 400 can be implemented on system 100. Persons skilled in the art may choose to implement method 400 on system 100 or variants thereon, or with certain blocks omitted, performed in parallel or in a different order than shown. Method 400 can thus also be varied. However, for purposes of explanation, method 400 as per the flow chart of FIG. 4 and will be described in relation to its performance on system 100 with a specific focus on engine 104 and its interactions with the other nodes in system 100.

Block 404 comprises capturing image frames of the subject. In the example of FIG. 1 and system 100, block 404 is performed by one or more capture devices 108 which receive telemetry information, typically frames of images, of room 204. As part of block 404, each image frame may be associated with a scanning time indicating the time at which the image frame was captured. The scanning time does not necessarily comprise a precise time stamp and instead may indicate a period of time. In some examples, the scanning time comprises a unique identifier associated with all the images captured during the scan.

It is envisioned that a plurality of image frames is captured. In most cases, more than one capture device 108 will be employed during many different performances of method 400. Each capture device 108 may also only capture a portion of frames that are needed to build an entire digital twin of room 204. Since no single device 108 is required to capture images of the entire subject, the processing demands on the devices 108 and network 112 are balanced. The fixed capture devices 108 including mounted camera device 108-1 can consistently capture what is in their field of view. However movable devices 108-2, 108-3, 108-4 . . . 108-n can be used to capture the remainder of the room 204. Thus, method 400 is performed for a plurality of capture devices 108, and in fact, a mixture of capture devices 108 may be preferred.

The more capture devices 108 that perform method 400, the better the digital twin that can be constructed. Furthermore, the frequency that method 400 is performed by different devices 108 will further influence degree to which the digital twin of room 204 is “real-time”. Method 400 is thus ideally performed at intervals during which room 204, including the objects therein, can be expected to change. For example, if fire extinguisher 124 is the only object that changes, and it is removed from the wall once a day and returned the next day, then an ideal frequency would be to perform method 400 with some device 108 that captures the location within room 204 of fire extinguisher 124.

Returning to FIG. 4, block 408 comprises establishing a root. Block 408 contemplates selecting a frame and/or other absolute point reference in the images captured at block 404 that can be used in comparison with other images captured from other device 108 during other performances of method 400. Establishing the root can also be termed “relocalization” and can include pose estimation. In general sense, establishing a root means mapping the augmented reality coordinate system in relation to a reference frame or feature. Pose information for frames may then be estimated relative to the root. During the first performance of method 400, such a coordinate system can be defined as part of the block 408. Typically, a root is established for a set of image frames captured in the current scanning session or scanning time to mitigate temporal changes in the room 204.

Block 412 comprises transmitting the frames from block 404 for processing. In system 100, image frames obtained by capture device 108 at block 404 are sent to engine 104 for such processing. As previously discussed, the image frames can be transmitted to the engine 104 in small batches, and it is not necessary to accumulate a scan of the entire room before sending image frames to the engine 104. As a further part of block 412, capture device 108 may transmit any other telemetry data that was captured at block 404.

Block 416 comprises aligning the frames with existing frames in the digital twin. In system 100, block 416 is typically performed by engine 104, but in other examples described herein, block 416 may be performed by capture device 108. When method 400 is performed for the first time, block 416 is obviated as there are no existing frames. However, each subsequent time block 416 is performed, engine 104 examines the frames received at block 404, in view of the root established at block 408, and creates an alignment of the frames from block 412 with the existing set of frames that define a digital twin from a previous iteration of method 400. In specific non-limiting examples, block 416 includes executing a structure from motion (SfM) algorithm, SLAM algorithm, or any other suitable method of estimating pose.

It is also to be reemphasized that that the order of performance of various blocks in method 400 can vary or occur in parallel. For example, block 408 may occur after block 416, or the root established at block 408 may be updated iteratively throughout method 400 as more information is collected and the location of the root can be verified. In another example, the root may be identified at block 408 before scanning begins at block 404.

For greater clarity, the order of blocks 404 to 416 may depend on the processing capabilities of the particular device 108 and the type of telemetry data collected. Specific, non-limiting variants are described herein.

In a first variant of the method 400, a Simultaneous Localization and Mapping (SLAM) algorithm is used for pose estimation. In particular embodiments, block 404 includes generating video frames and sensor data representing the room 204 and further generating inertial measurement units (IMU) representing the movement of the device 108 within the room 204. As part of block 404, device 108 may estimate pose information for each frame based on outputs from the SLAM algorithm. At block 416, the device 108 aligns the image frames with the existing frames based at least in part on the pose information generated by SLAM. As part of block 416, the SLAM algorithm further localizes the device 108 within the room 204. As the device 108 moves within the room 204, the SLAM algorithm continuously or periodically updates the location information and frames. After aligning the frames, the method proceeds to block 412 which comprises transmitting the frames from the device 108 to the engine 104. Block 420 further comprises conducting bundle adjustment at the engine 104 for optimization. While SLAM allows for accurate localization and mapping in real-time, SLAM is resource-intensive and devices 108 with limited processing capacity are not suited to performing SLAM.

In a second variant of the method 400, only video frames are captured at block 404, and no other sensor or IMU data is collected and therefore no pose information is generated. In this variant, blocks 404, 408, and 412 are performed at device 108 while block 416 is performed at engine 104. Block 416 includes processing the video frames with a Structure from Motion (SfM) algorithm at engine 104. This variant of the method is universally applicable to all capture devices 108 with video capability, but it is susceptible to motion blur, especially in low-light conditions due to shutter speed limitations.

In a third variant of the method 400, photos are taken only while the capture device 108 is not moving. In this variant, the capture device 108 is a movable capture device which may periodically move and periodically halt. The movable capture device 108 includes at least one IMU sensor to detect whether the capture device 108 is in motion or stationary. Block 404 is performed in response to the IMU sensor detecting that the capture device 108 is at least momentarily stationary, and thus the photos obtained are less blurry.

In a fourth variant of the method 400, the capture device 108 executes a SLAM algorithm to generate pose information using photos. In particular examples, capture device 108 executes the SLAM algorithm at block 404 using the ARKit™ application programming interface (Google) to generate the pose information. The pose information is transmitted to engine 104 at block 412.

For devices 108 that do not perform SLAM, pose estimation may be conducted hierarchically. Generally, hierarchal pose estimation is conducted at engine 104 which receives image frames from one or more devices 108 at block 412. Engine 104 conducts an initial pose estimation for the image frames. associated with a pre-determined scanning time. Once the poses are estimated, engine 104 selects one or more reference images from the existing images. Preferably, the reference images depict easily recognizable features or objects in the room 204 which are unlikely to change or be obstructed, such as wall paintings or non-repeating structural features of the room 204. Suitable reference images can be selected by machine-learning algorithms or by user input. Next, the reference images are mixed with the image frames and the pose estimation is repeated to estimate the poses of the reference images. Based on the comparison between the calculated poses for the image frames and the reference images, the poses for the image frames can be updated. This hierarchal pose estimation can further correct the scaling in-accuracy caused by the SfM method and intrinsic estimation.

Block 420 comprises building an intermediate digital twin. Various ways of performing block 420 are contemplated, and a specific example will be discussed further below.

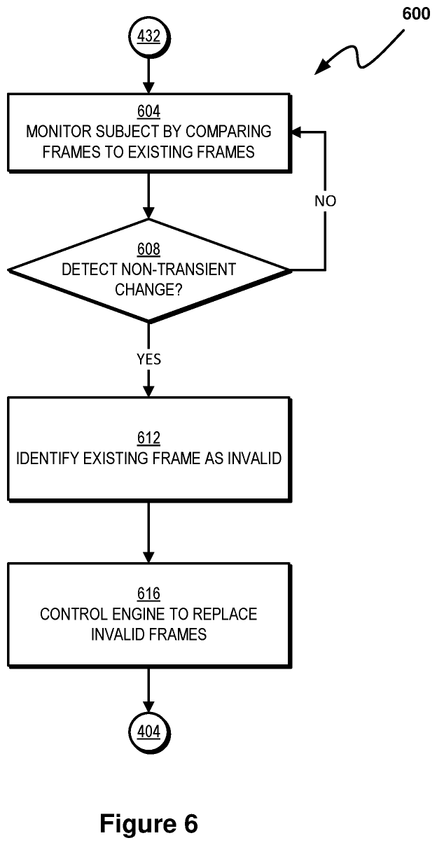

Block 424 comprises aligning the image frames according to scanning time to build the final digital twin. Block 424 comprises identifying the most recent image frame corresponding to each segment of the subject and building the digital twin from the most recent image frames. In some examples, the digital twin will be built from entirely from image frames associated with a single scanning time, however the digital twin is more commonly built from image frames obtained at various scanning times, since a complete scan of the room 204 is not generally performed. Engine 104 preferentially selects image frames from the most recent scanning time to build the digital twin but can incorporate older image frames to cover segments of the room that were not captured during the most recent scanning time. If no image frames from any scanning time are available to populate a particular segment of the room 204, the segment may be left blank. As will be explained in greater detail later with respect to FIG. 6, an image frame may be omitted from the digital twin if the frame is deemed to be out of date.

The digital twin from block 424 is then indexed at block 428 and at block 432 stored in non-volatile memory 316 in association with the scanning time. During deployment, the digital twin is made available for retrieval and access at devices 116. Engine 104 can be configured to provide versions of the digital twin from block 436 according to the hardware specifications of each device 116, since some devices 116 are enabled for 3D virtual reality rendering (e.g., device 116-1 and device 116-o) while others are two dimensional (e.g., device 116-2 and device 116-3). Devices 116 may be configured to receive inputs selecting a scanning time via a user interface. In response to receiving input of a scanning time, the device 116 is configured to display a version of the digital twin associated with the selected scanning time. In a particular embodiment, device 116 displays a slider which controls the device 116 to retrieve and display newer or older versions of the digital twin. Thus, a user seeking to confirm which components were installed inside an airplane fuselage before the insulation and panels were replaced can use the slider to view an earlier version of the digital twin which was generated during the installation process.

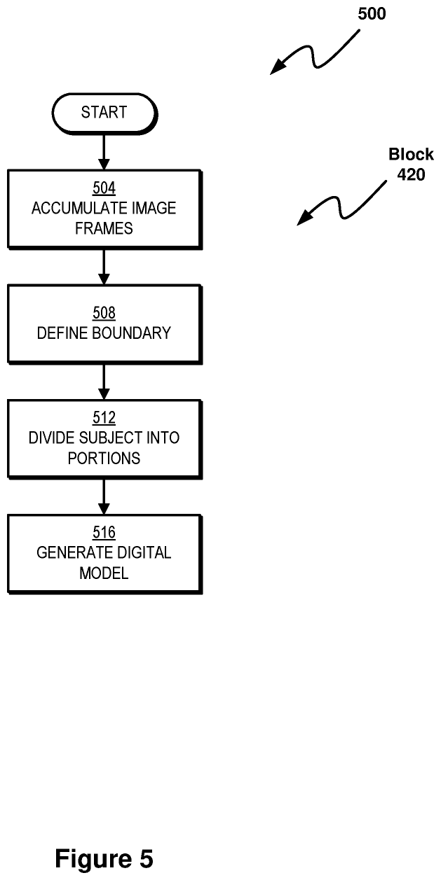

One non-limiting method of performing block 420 is shown in FIG. 5. At block 504, frames are accumulated until a sufficient number have been obtained to build or generate the digital twin. Put in other words, frames are accumulated in order to obtain sufficient coverage of the digital twin of room 204. Note that method 400 and block 404 can include accumulation of fragments of images or frames that are needed for an entire digital twin generation, and thus block 504 contemplates accumulation of those frames until a sufficient number are available (or sufficient coverage has been achieved), to either build an entire digital twin or to update a segment thereof. A time period can also be defined, in that the frames must be gathered at block 504 within a certain time period or else they are considered “stale” and unusable.

Block 508 comprises defining a boundary for the subject. The boundary may be defined by inputs received at device 116 or by engine 104 in response to the availability of image frames. If sufficient frames exist at block 504, then the boundary can be the perimeter of the entire room 204, however, if, for example, only a sufficient number of frames exist to update the status of fire extinguisher 124, then the boundary at block 520 can be limited to the region of room 204 that includes the location of fire extinguisher 124. In another example, a user may define the boundary around the fire extinguisher 124 using a mouse and keyboard, or other input device connected to device 116. Thus, block 508 helps to conserve processing power by processing images only in a region of interest.

Block 512 comprises dividing the subject into segments. Block 512 complements block 508, in that the room 204 can be divided into segments. In one example, the segments are defined by a pre-defined grid and segment size is defined according to the memory limitations of engine 104. In another non-limiting example, the segments are defined to include whatever updates are available based on whichever capture devices 108 have triggered invocation of method 400. As a further part of block 512, engine 104 identifies frames associated with each segment. To reduce processing time, the engine 104 may identify frames associated with two or more segments in parallel.

Block 516 comprises generating the digital twin by assembling the segments identified at block 512. In system 100, block 516 is performed by engine 104 which executes one or more modelling algorithms to reconstruct the digital twin from the portions. Suitable modelling algorithms include Truncated Signed Distance Function (TSDF) Volume, point clouds, textured mesh, Gaussian splats, Neural Radiance Fields (NERFs), surface reconstruction, and the like. To conserve computational resources, segments may be assembled one by one, or a few at a time until all the segments have been assembled into the digital twin. The various time stamps associated with each segment from block 512 can indicate when a sufficient number of captures and invocations of method 400 have occurred in order to confidently update the digital twin that is available to devices 116 as being near or substantially real-time to the actual state of room 204. In this manner, users of devices 116 can be provided with a confidence interval as to actual state of room 204 when they are accessing its digital twin.

As compared with approaches where the subject is processed all at once, block 512 addresses computing power limitations, improves cost efficiency, and enhances algorithm performance.

Capture devices 108 with fixed viewpoints, such as mounted camera device 108-1, further enhance the accuracy and efficiency of scene segmentation in fixed environments. By continuously observing a portion of the environment and employing a monitoring algorithm, the system can identify certain segments of the previously generated digital twin as invalid based on detected activities. An exemplary monitoring method is shown in FIG. 6 at 600. Generally, method 600 is performed after a digital twin is built at block 424, although in some examples, method 600 is performed after indexing at block 428 or storing and deploying at block 432.

Block 604 comprises monitoring the subject and in system 100, block 604 is performed by capture device 108, particularly a fixed device 108, which continuously or periodically generates image frames of the subject. At block 608, the monitoring algorithm determines whether or not a non-transient change has occurred in the room 204. The determination may be made by comparing one of the frames to a previously generated frame. The monitoring algorithm may be executed at the device 108 or at the engine 104. Several suitable algorithms are contemplated for monitoring the subject including background subtraction, frame differencing, machine learning and deep learning, foreground detection, and change detection algorithms, however the monitoring algorithm is not particularly limited.

If the monitoring algorithm determines that no change has occurred or the change is transient, the device 108 continues monitoring the subject. In a specific non-limiting example, the mounted camera device 108-1 detects motion in the environment and determines that the motion is caused by an individual walking through the room 204. The algorithm returns to block 604 and may mark the image frame as valid, indicating that the digital twin is up-to-date and accurately represents the subject room 204.

If the monitoring algorithm determines that a non-transient change has occurred, the device 108, the algorithm identifies the image frame as invalid, as indicated at block 612. The invalidity marker may be further applied to a segment of the digital twin surrounding the invalid frame. At block 616, the algorithm controls one or more of the capture devices 108 to replace the invalid segment during subsequent performance of method 400. Replacing the invalid segment generally entails controlling the capture devices 108 to generate replacement image frames depicting the invalid segment at block 404. Engine 104 may further control drone 108-n to move towards the portion of the room 204 represented by the invalid segment of the digital twin, or control device 108 to display instructions for the user to move towards the relevant portion of the room 204 in order to better capture replacement image frames. As a further part of block 616, the algorithm may control engine 104 to remove the invalid frame from the digital twin or otherwise update the user interface so to indicate to the user that the relevant segment may be out of date and requires updating. This approach can maintain the currency of digital twin while ensuring that computational resources are used optimally.

Monitoring is not limited to fixed capture devices, and bodycams or augmented reality (AR) headsets with capture devices 108 can complement the fixed viewpoints of security cameras. Bodycams and AR headsets provide dynamic, real-time perspectives of objects as the objects are examined or manipulated by users in the room 204. As the user moves through the environment, wearable capture devices 108 can capture detailed, close-up views of activities and changes to the environment. These frames may be analyzed, as described above with respect to FIG. 6, to detect any significant changes in the environment, and mark corresponding segments as invalid. Updated frames from the wearable capture devices 108 are then used to refresh the digital twin. This bidirectional approach leverages the mobility of wearable devices to enhance the efficiency of scene segmentation and reconstruction. This integrated approach ensures comprehensive and up-to-date monitoring and scene reconstruction.

A person skilled in the art will now appreciate that the teachings herein can improve the ability for remote inspection and other retrieval of information about room 204, or other subjects. For example, the present teachings improve over a straight “video feed” of room 204, which is not three-dimensional and lacks other potential telemetry captures and can therefore only include a portion of the room and is not capable of virtual navigation. Therefore, such a video feed is of limited use to users of devices 116, and indeed historical captures may be needed. The real time (or near real time, or periodically updated) version of the digital twin of room 204, on the other hand, can allow for a complete navigation and inspection of the room 204, according to the richness and depth and frequency of captures from devices 108.

This continuous, real-time data collection system offers many improvements to existing data capture systems. With devices such as headsets, the user does not need to be explicitly directed to scan the whole environment, and instead the camera can collect data as the user navigates throughout the workspace. Headsets can also work in tandem with the phone or other capture devices. Since the headset is mounted on a user's head, it is suitable for collecting data up close as the user needs to bend over and come close to the subject.

In view of the above it will now be apparent that variants are contemplated. For example, the method and system are described with respect to generating a digital model of a room, however the teachings could be similarly applied to other environments including entire buildings, outdoor spaces, caves, vehicles, and the like.

With the newly established system, input frames are not necessarily obtained from a single source or user. Once sufficient information is collected, the system can start segmenting image frames into time slices.

This opens up doors for other sensors such as cameras and sensors mounted on robots (dogs, rovers, drones, etc.), vehicles (such as forklifts), or even versions of security cameras, which we'll refer to collectively as “movable capture devices”. Once body-mounted cameras such as augmented reality (AR) headsets become common and widely adopted, there may be hundreds of data sources from the workers in an environment. Instead of using the data from a single source, the system 100 can merge data from multiple sources that were generated during the same time period. The data can be used to generate the mesh periodically or continuously, depending on the density of data the entire system can capture.

Data from fixed devices can be incorporated with other data sources that are streamed from multiple users and robotic devices. Since fixed devices have limited fields of view, these alone may not be sufficient to recreate the mesh with a satisfactory level, but fixed capture devices can be used to identify the areas that need to be updated as they are constantly monitoring activity within the area. This information can be used to guide users or robots to navigate the area and collect relevant telemetry data.

For instance, the mounted capture device can identify a forklift unloading cargo to a location. Even if the mounted capture device cannot capture high quality images of the cargo, this information can be used to guide a user, drone, or robotic dog to walk around the area gathering additional visual information. This allows the system to be up to date with the digital twin at all times. Optimizing accuracy can be further improved by equipping all moving objects in the region of interest with capture devices.

This new scanning approach will enable continuous data collection (in the background) and continuously update the digital twin of the environment. And this data enables the system to visualize the space in a desired by time by using user interface (UI) elements such as a slider on the client-facing portal. Any of the above proposed new logic can be done on the cloud, or on the device, or on a local edge server or a combination of such processing devices. And based on the requirements and environmental conditions, it can be set up in different ways.

A person of skill in the art will now appreciate that the method and system described above provide numerous advancements to modern surveillance technology. The system enables the continuous recording and compilation of a three-dimensional model without overtaxing the available computing resources. This is achieved by capturing portions of the space incrementally, processing the scans by segment rather than collectively, and prioritizing segments of the space that exhibit change. Potential applications include industries where quality control and compliance are prioritized, including pharmaceutical manufacturing, aerospace maintenance, logistics and shipping, and food and beverage production, It should be recognized that features and aspects of the various examples provided above can be combined into further examples that also fall within the scope of the present disclosure. In addition, the figures are not to scale and may have size and shape exaggerated for illustrative purposes.

1. A method of computing a digital twin, the method comprising:
capturing, at a plurality of capture devices (108), image frames representing the subject at respective scanning times;
establishing a root in at least one of the image frames, and estimating pose information for each image frame, relative to the root;
transmitting the image frames from the plurality of capture devices (108) to a digital twin engine (104);
aligning the image frames with existing frames in the digital twin based on feature matching and the pose estimation;
building an intermediate digital twin, at the digital twin engine (104), based on the alignment of the image frames; and
aligning image frames, at the digital twin engine (104), according to the respective scanning times to build the final digital twin.

2. The method of claim 1, wherein the method is performed continuously or periodically to update the digital twin.

3. The method of claim 1, wherein building the intermediate digital twin comprises:
accumulating image frames from the plurality of capture devices (108);
defining a boundary for the subject;
dividing the subject into segments; and
building the intermediate digital twin by assembling the segments.

4. The method of claim 1 wherein the plurality of capture devices includes both fixed capture devices and movable capture devices, the method further comprising:
monitoring the subject by capturing image frames at one of the fixed capture devices and comparing the image frames to the existing frames;
determining whether a non-transient change has occurred in the subject based on the comparison;
if no non-transient changes have occurred, continuing to monitor the subject;
if a non-transient change has occurred, identifying a segment of the digital twin associated with the image frame as invalid;
controlling one of the movable capture devices to capture replacement image frames of the invalid segment; and
updating the digital twin based with the replacement image frames.

5. The method of claim 1 further comprising:
estimating pose information for the image frames;
selecting reference images from the existing images;
estimating pose information for the reference images;
comparing the pose information of the image frames with the pose information of the reference images; and
correcting the pose information for the image frames based on the comparison.

6. The method of claim 1, wherein the plurality of capture devices (108) includes a first capture device (108) and a second capture device (108), and the image frames captured by the first and second capture devices are processed according to the processing capacities of the respective capture devices.

7. The method of claim 6, wherein the image frames comprise video frames and the first capture device further collects inertial measurement unit (IMU) data, the method further comprising:
estimating the pose information for each image frame at the first capture device (108) using a simultaneous localization and mapping (SLAM) algorithm;
wherein aligning the image frames with the existing frames is performed by the first capture device (108).

8. The method of claim 6, wherein the image frames comprise video frames, wherein aligning the image frames with the existing frames comprises executing a structure from motion (SfM) algorithm at the digital twin engine (104).

9. The method of claim 6, wherein:
the first capture device (108) is movable and includes an IMU sensor to detect
when the first capture device (108) is currently stationary, and
capturing the image frames is performed only while the first capture device (108) is stationary.

10. The method of claim 6, wherein the image frames include photos, the method further comprising:
estimating the pose information for each image frame at the first capture device (108) using an ARKit™ application programming interface and a simultaneous localization and mapping (SLAM) algorithm.

11. A system for computing a digital model of a subject, the system comprising:
a plurality of capture devices (108) configured to generate image frames representing a portion of the subject at respective scanning times;
a digital twin engine (104) configured to:
receive the image frames from the plurality of capture devices via a network;
establish a root in at least one of the image frames;
align the image frames with existing frames in the digital twin based on the root;
build an intermediate digital twin based on the alignment of the image frames; and
align the image frames with the respective scanning times to construct the final digital twin; and
a retrieval computing device (116) for outputting the digital twin.

12. The system of claim 11, the plurality of capture devices including at least a first capture device configured to establish the root and align the image frames with the existing frames.

13. The system of claim 11, wherein the plurality of capture devices (108) includes one or more of a video camera, a video phone, a digital camera, a headset, a tablet computer, and a drone.

14. The system of claim 13, wherein the plurality of capture devices (108) includes both fixed capture devices and movable capture devices.

15. The system of claim 11, wherein the retrieval computing device (116) is selected from the group consisting of a virtual reality device, a personal computing device, a smartphone, a tablet computer, and an augmented reality device.

16. The system of claim 11 wherein the plurality of capture devices (108) includes at least a first capture device including a sensor for capturing telemetry data.
